(19) United States
(12) Patent Application Publication
(10) Pub. No.: US 2014/0332423 A1
(43) Pub. Date: Nov. 13, 2014

(54) TOOL BOX

(71) Applicant: Hong-Jen Lee, Taichung (TW)

(72) Inventor: Hong-Jen Lee, Taichung (TW)

(21) Appl. No.: 13/889,325

(22) Filed: May 7, 2013

(51) Int. Cl. B25H 3/02

(52) U.S. Cl. CPC B25H 3/02
USPC 206/349

(57) ABSTRACT

A tool box includes a body, support frames, a part box, a power supply member and an illumination member. The body includes a top part and a bottom part. The support frames are connected to two sides of the body. The part box and the power supply member are connected to the body. The illumination member is powered by the power supply member.

### FIELD OF THE INVENTION

The present invention relates to a tool box, and more particularly, to a tool box with illumination member connected thereto.

### BACKGROUND OF THE INVENTION

A conventional tool box 90 is shown in FIG. 25 and generally includes a bottom part 91 and a top part 92 which is pivotably connected to the bottom part 91. When the top part 92 is mounted to the bottom part 91, a locking unit 93 is used to secure the top and bottom parts 92, 91.

The tool box 90 is usually put on the floor or ground which can easily contaminate the surfaces of the tool box 90. When the tool box 90 drops on the floor or the ground, the locking unit 93 is opened and the tools in the tool box 90 drop out from the tool box 90. The conventional tool box 90 is designed to receive tools and accessories cannot be conveniently received and the users have to purchase another box for the accessories. The conventional tool box 90 does not have proper illumination feature so that the users have to carry other illumination devices which are another burden for the users. The conventional tool box 90 has limited function.

The present invention intends to provide a tool box which provides multiple functions and improves the shortcomings of the conventional tool box.

### SUMMARY OF THE INVENTION

The present invention relates to a tool box and comprises a body, support frames, a part box, a power supply member and an illumination member. The support frames support the tool box to stand upright and the part box receives parts. The illumination member provides illumination for the users.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the tool box of the present invention;

FIG. 2 is a perspective view to show the tool box of the present invention;

FIG. 3 shows another exploded view of the tool box of the present invention;

FIG. 4 is a perspective view to show the second embodiment of the tool box of the present invention;

FIG. 5 is a perspective view to show the third embodiment of the tool box of the present invention;

FIG. 6 is a perspective view to show the fourth embodiment of the tool box of the present invention;

FIG. 7 is an exploded view to show the fifth embodiment of the tool box of the present invention;

FIG. 8 is a cross sectional view to show the fifth embodiment of the tool box of the present invention;

FIG. 9 is the enlarged view of the area designated by C in FIG. 5;

FIG. 10 is an exploded view to show the sixth embodiment of the tool box of the present invention;

FIG. 11 is a cross sectional view to show the fifth embodiment of the tool box of the present invention;

FIG. 12 is the enlarged view of the area designated by C in FIG. 11;

FIG. 13 is an exploded view to show seventh embodiment of the tool box of the present invention;

FIG. 14 shows that the illumination member is not yet extended;

FIG. 15 shows that the illumination member is extended;

FIG. 16 is an exploded view to show the eighth embodiment of the tool box of the present invention;

FIG. 17 is an exploded view to show the ninth embodiment of the tool box of the present invention;

FIG. 18 is an exploded view to show the tenth embodiment of the tool box of the present invention;

FIG. 19 shows the ninth embodiment of the tool box of the present invention stands upright;

FIG. 20 is an exploded view to show the tenth embodiment of the tool box of the present invention;

FIG. 21 is a perspective view to show the tenth embodiment of the tool box of the present invention;

FIG. 22 is a perspective view to show that the tenth embodiment of the tool box of the present invention is opened;

FIG. 23 is an exploded view to show the eleventh embodiment of the tool box of the present invention;

FIG. 24 shows that the part box is pulled from the twelfth embodiment of the tool box of the present invention, and

FIG. 25 shows the conventional tool box.

### DETAILED DESCRIPTION OF THE PREFERRED EMBODIMENT

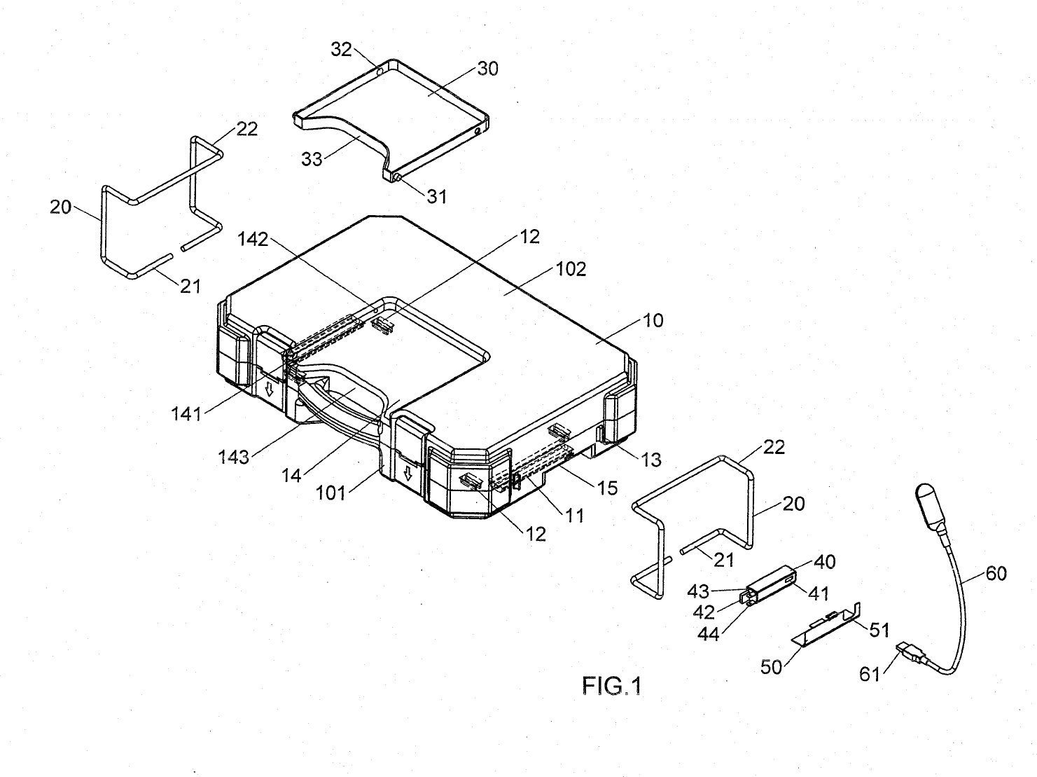

Referring to FIG. 1, the tool box of the present invention comprises a body 10, multiple support frames 20, a part box 30, a power supply member 40, a cover 50 and an illumination member 60. The body 10 receives tools therein and comprises a bottom part 101, a top part 102 and a locking unit. The body 10 has two first pivotable portions 11, and two first engaging portions 12 are located close to each of the first pivotable portions 11. Each first engaging portion 12 is a slot. The body 10 has two second engaging portions 13 on each of two sides thereof and each second engaging portion 13 is a slot and located corresponding to the first engaging portion 12. The first pivotable portions 11, the first engaging portions 12 and second engaging portion 13 are located on the bottom part 101. The body 10 has at least one recessed area 14, in this embodiment, there is only one recessed area 14 and located at the top part 102. Two third pivotable portions 141 are formed on two sides of the recessed area 14 respectively, each third pivotable portion 141 has a first positioning portion 142 which is a boss. The recessed area 14 has a first recess 143 which defines a gap relative to the handle, so that the user can conveniently hold the handle. A reception recess 15 is defined in one side of the body 10 and located at the bottom part 101. The number of the support frame 20 and the number of the first pivotable portion 11 is the same. Each of the support frames 20 is made by bending a tube into two U-shaped portions, each support frame 20 having two second pivotable portions 21 on two distal ends thereof so as to be pivotably connected the first pivotable portions 11. Each support frame 20 has two leg portions 22 which are located corresponding to the first pivotable portions 11 when the second pivotable portions 21 are pivotably connected the first pivotable portions 11. The second pivotable portions 21 are located at bottom of the body 10 and the leg portions 22 are located on top of the body 10. The support frames 20 are mounted to two sides of the body 10 and each support frame 20 is engaged with the second engaging portion 13 so that the support frames 20 do not separated from the body 10. The part box 30 is shaped the same as the recessed area 14 so as to be engaged with the recessed area 14. The two fourth pivotable portions 31 are formed on two sides of the part box 30 respectively and pivotably connected to the third pivotable portions 141 of the body 10. The part box 30 has a second positioning portion 32 which is a recess with which the first positioning portion 142 is engaged so that the part box 30 is engaged with the recessed area 14. The part box 30 has a second recess 33 which has the same curvature as the first recess 143. When the second positioning portion 32 is separated from the first positioning portion 142, the part box 30 is pivotable relative to the body 10. Parts and accessories are received in the part box 30. The power supply member 40 is located in the reception recess 15 and has at least one power supply end and multiple charging terminals 42/43/44 of different specifications, the at least one power supply end is a USB port so as to be connected with a computer or a power supply that has a USB connector. The cover 50 is located in the reception recess 15 so as to restrict the power supply member 40 in the reception area 15. The cover 50 has at least one second notch 51 from which the charging terminals 42/43/44 and the power supply end 41 are exposed. The illumination member 60 has a power supply terminal 61 (can be a USB connector) on one end thereof and the power supply terminal 61 extends through the second notch 51 and is connected to the power supply end 41 so that the illumination member 60 is powered by the power supply member 40. The illumination member 60 is connected with a flexible handle.

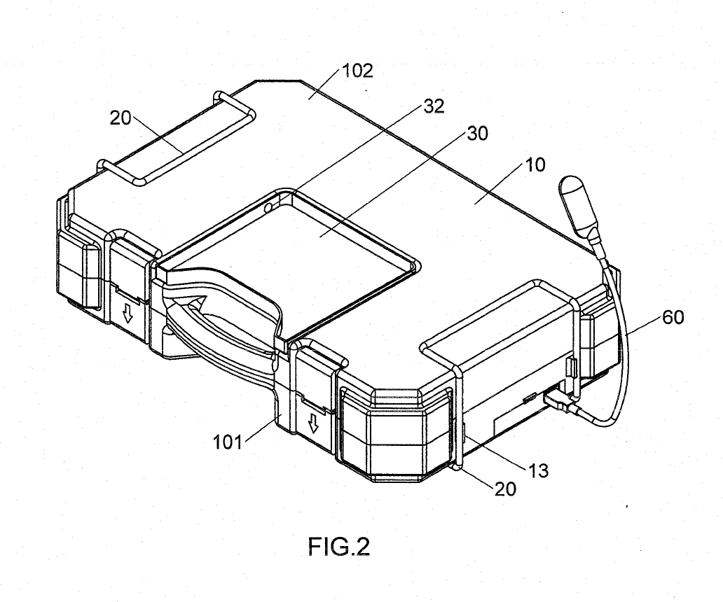

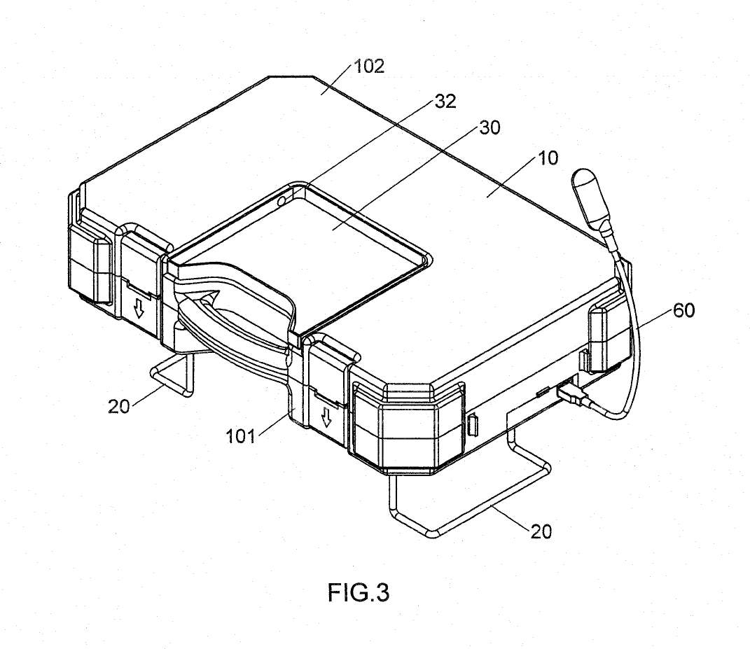

As shown in FIGS. 2 and 3, the support frames 20 are pivotably connected to the body 10 and the part box 30 is pivotably connected to the recessed area 14. The power supply member 40 and the cover 50 are located in the reception recess 15. The illumination member 60 is connected to the power supply end 41. When operating or pulling the support frames 20, the leg portion 22 of each support frame 20 is removed from the top of the body 10 and each of the support frames 20 is separated from the second engaging portion 13. Each of the two support frames 20 is pivoted about the first pivotable portion 11 and supports the bottom of the body 10. Each of the two support frames 20 is engaged with the first engaging portion 12 so that the body 10 stands on a surface by the support frames 20. The top part 102 can be used as a work bench. When the tool box is opened, the tools are received in the tool box and the part box 30 can be removed from the body 10, and the parts and accessories can be received in the part box 30. The illumination member 60 provides illumination to the top part 102. When not in use, the illumination member 50 can be removed from the power supply member 40 and received in the body 10.

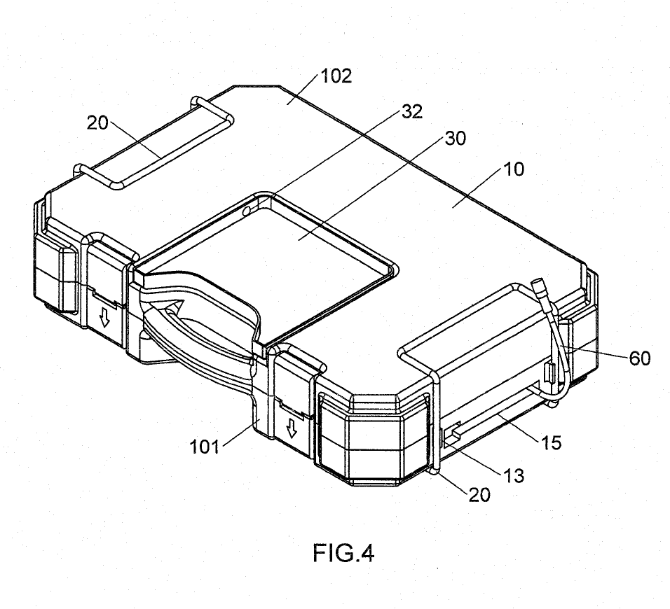

As shown in FIG. 4 which shows the second embodiment, wherein the reception recess 15 can accommodate the folded illumination member 60 while the power supply terminal 61 does not need to be separated from the power supply end 41. The illumination member 60 needs a switch on it so as to control it.

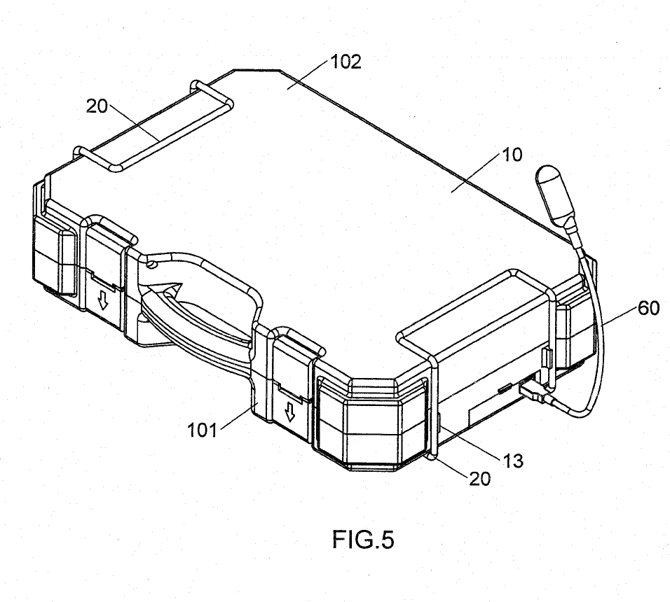

As shown in FIG. 5 which shows the third embodiment, wherein the body 10 does not have the recessed area 14 and no part box 30 is equipped.

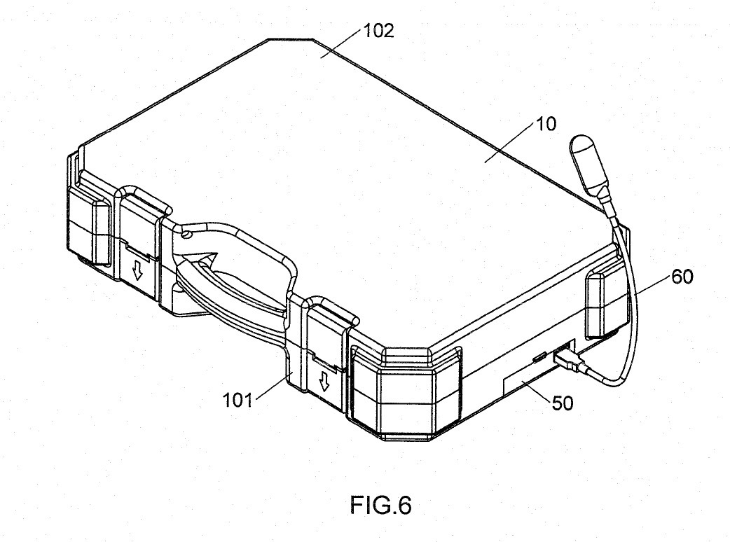

As shown in FIG. 6 which shows the fourth embodiment, wherein the body 10 does not have the first pivotable portions 11, the first engaging portions 12, the second engaging portions 13 and the recessed area 14, and no support frames 20 and the part box 30 either.

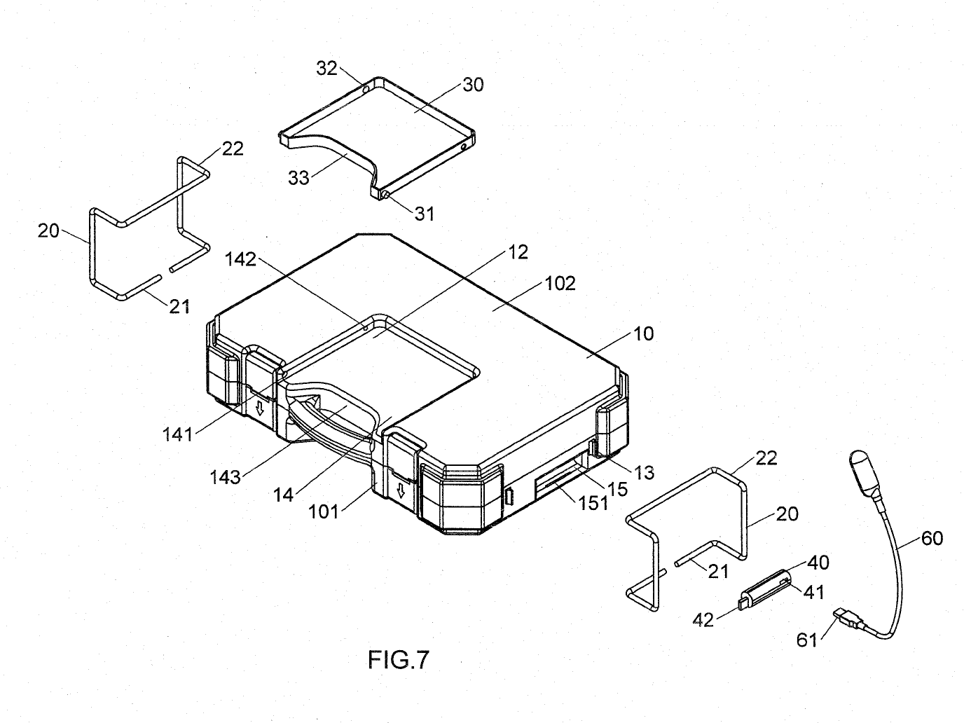

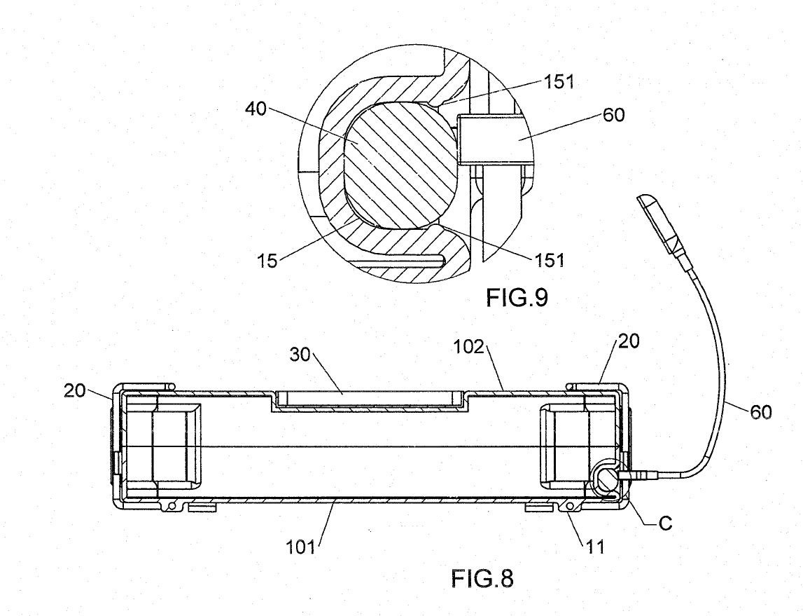

As shown in FIGS. 7 to 9, which show the fifth embodiment, wherein the reception recess 15 has multiple protrusions 151 located on two sides thereof. As shown in FIG. 9, each protrusion 151 is an elongate protrusion. The protrusions 151 restrict the power supply member 40 in the reception recess 15.

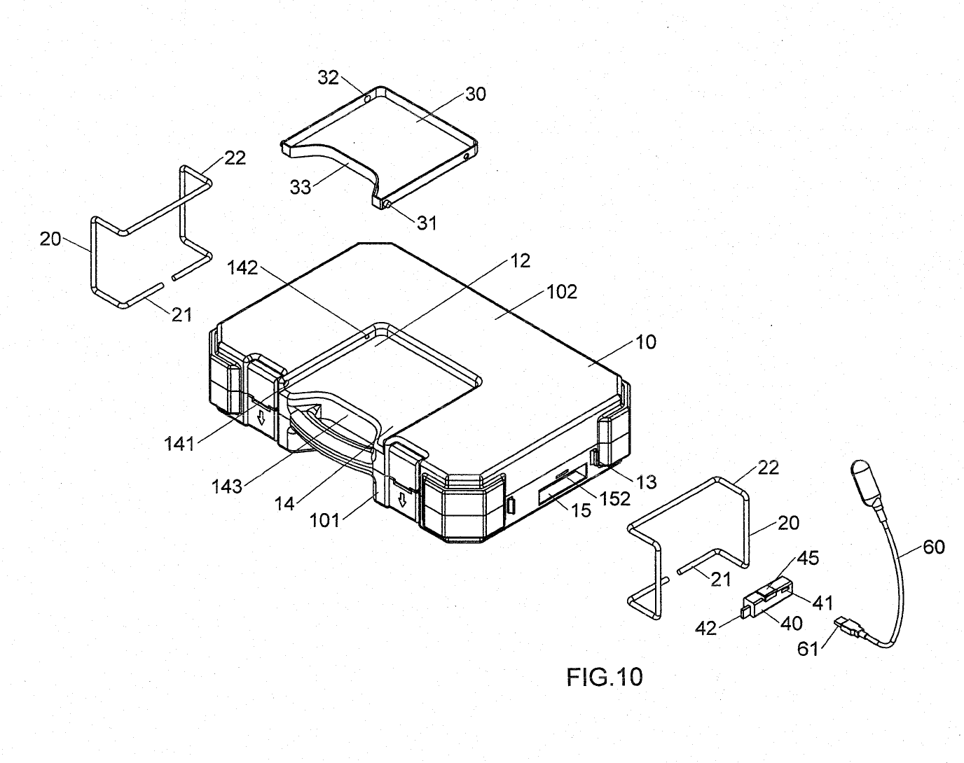

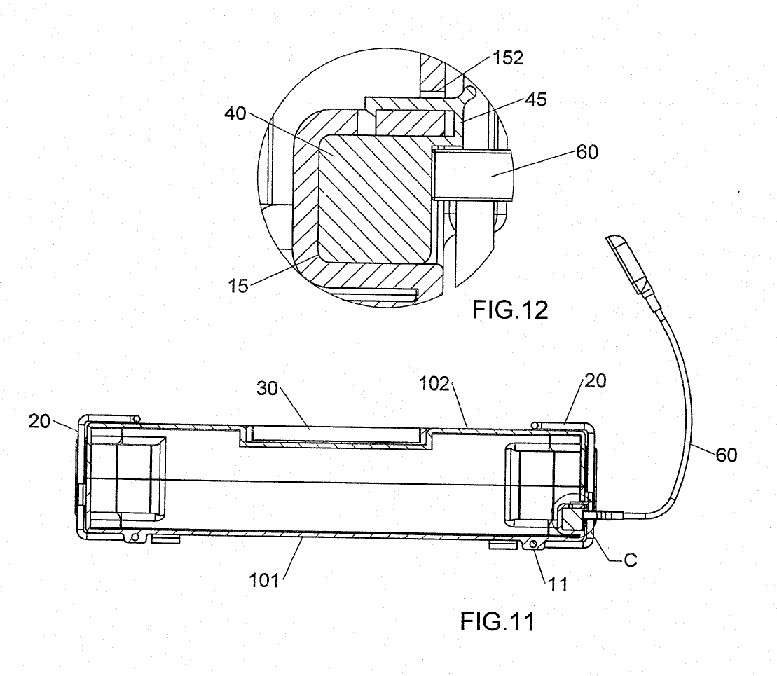

As shown in FIGS. 10 to 12, which show the sixth embodiment, wherein a locking recess 152 is defined above the reception recess 15 and the power supply member 40 has a locking portion 45 which is engaged with the locking recess 152 to position the power supply member 40 in the reception recess 15 as shown in FIG. 12.

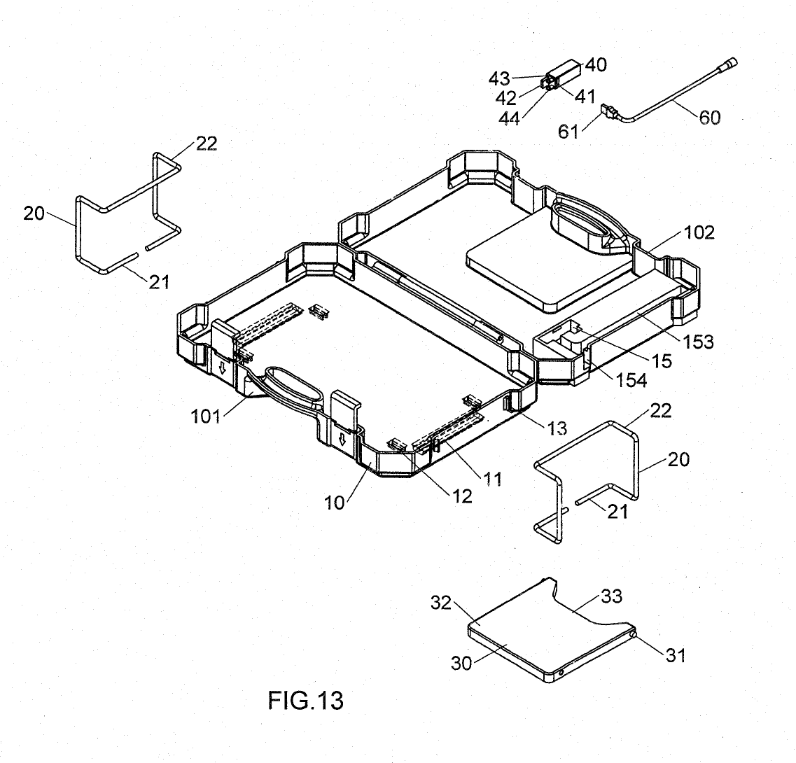

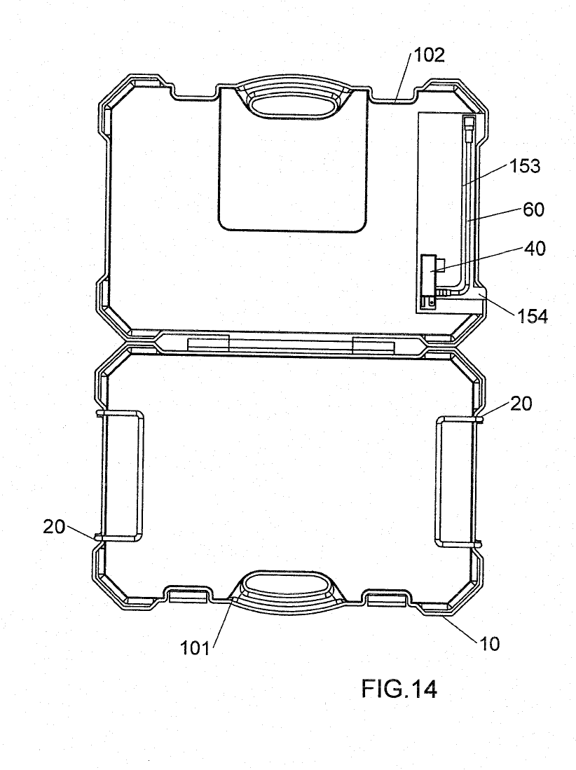

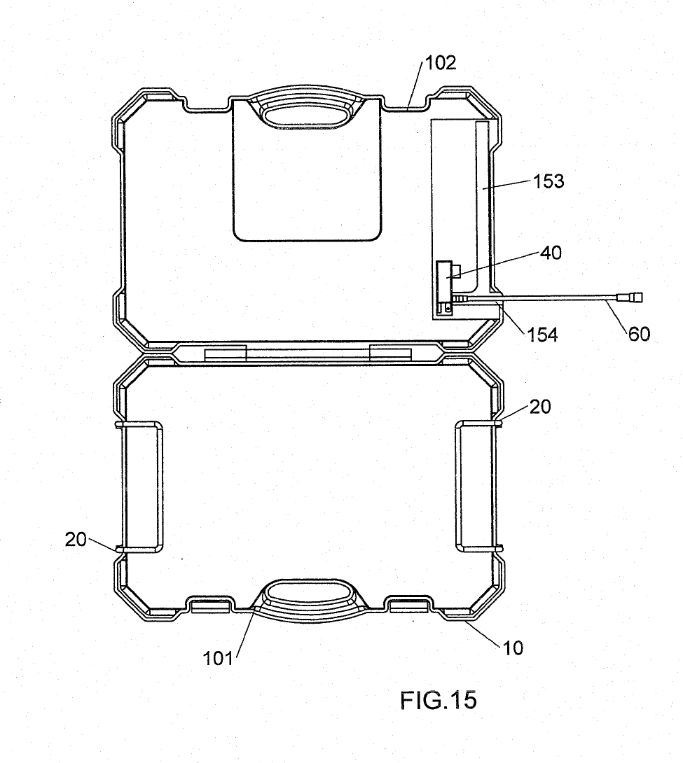

As shown in FIGS. 13 to 15, which show the seventh embodiment, wherein the reception recess 15 has a light reception portion 153 and a first notch 154 which opens to outside of the body 10. The reception recess 15 is located at the top part 102, when the power supply terminal 61 is connected to the power supply end 41, the illumination member 60 is bent and received in the light reception portion 153. As shown in FIG. 15, when using the illumination member 60, the illumination member 60 extends through the first notch 154 and protrudes beyond the body 10.

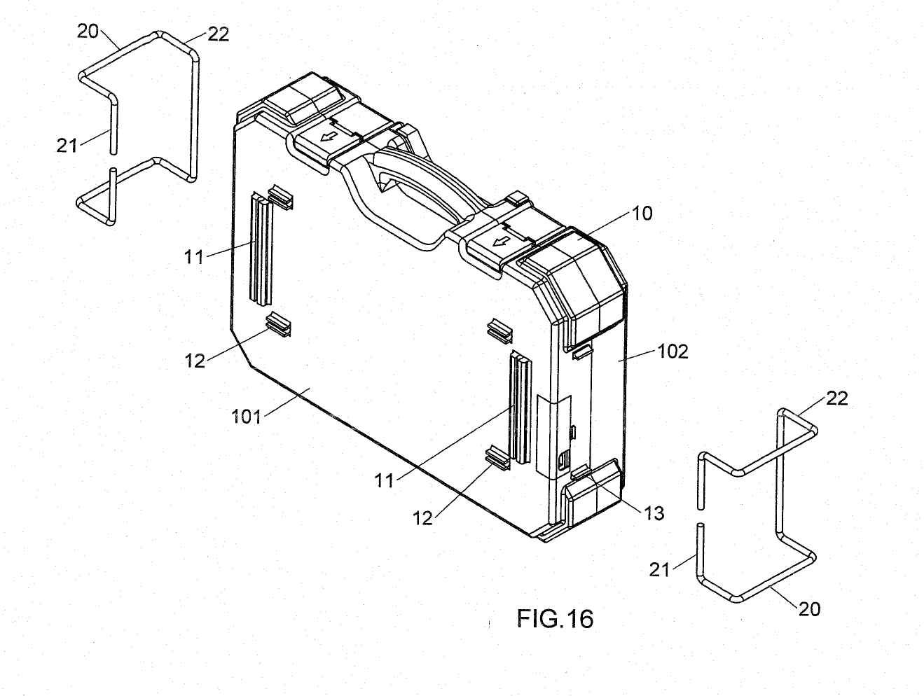

As shown in FIG. 16 which show the eighth embodiment, wherein the first pivotable portion 11 is a slot and the second pivotable portion 21 is engaged with the first pivotable portion 11 when the body 10 is formed.

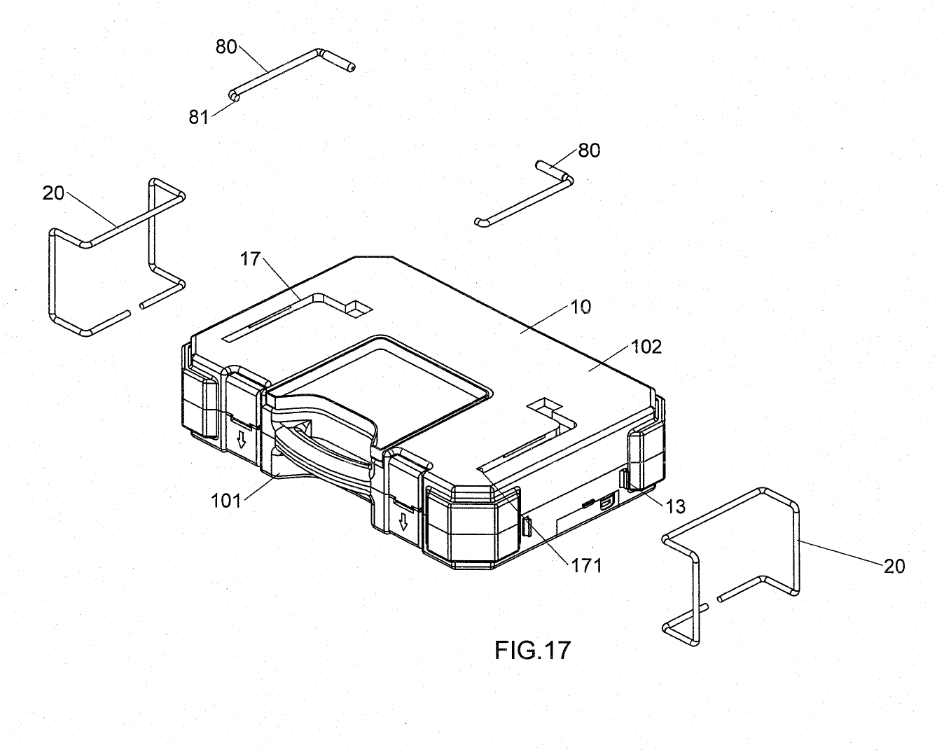

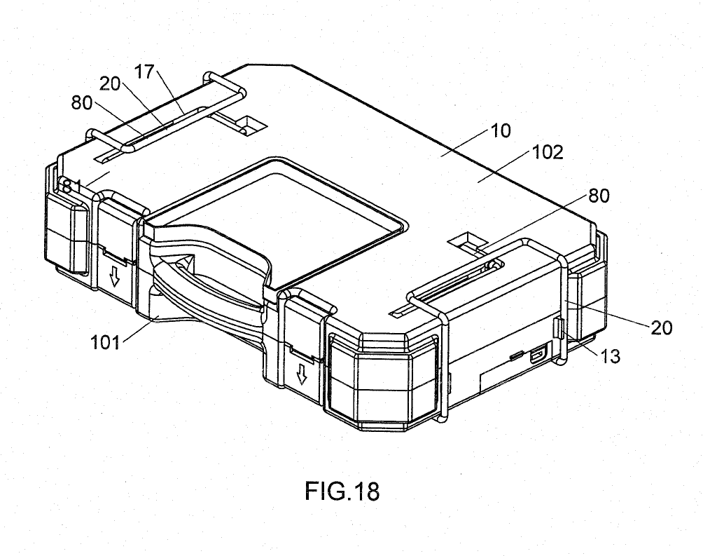

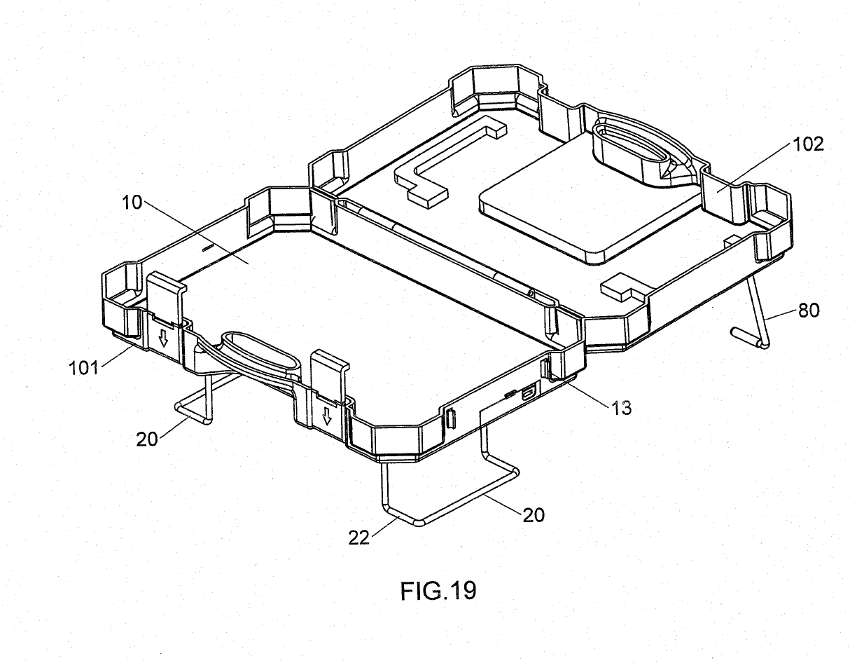

As shown in FIG. 17 which shows the ninth embodiment, wherein the body 10 has two first slots 17 defined in the top part 102 thereof. Each first slot 17 has a fifth pivotable portion 171 which is a hole. Multiple top portions 80 each have a sixth pivotable portion 81 which is pivotably connected to the fifth pivotable portion 171 so that each of the top portion 80 is pivotably engaged with the first slot 17. As shown in FIG. 19, when the body 10 stands upright, the support frames 20 support the bottom part 101 and the top portions 80 support the top part 102.

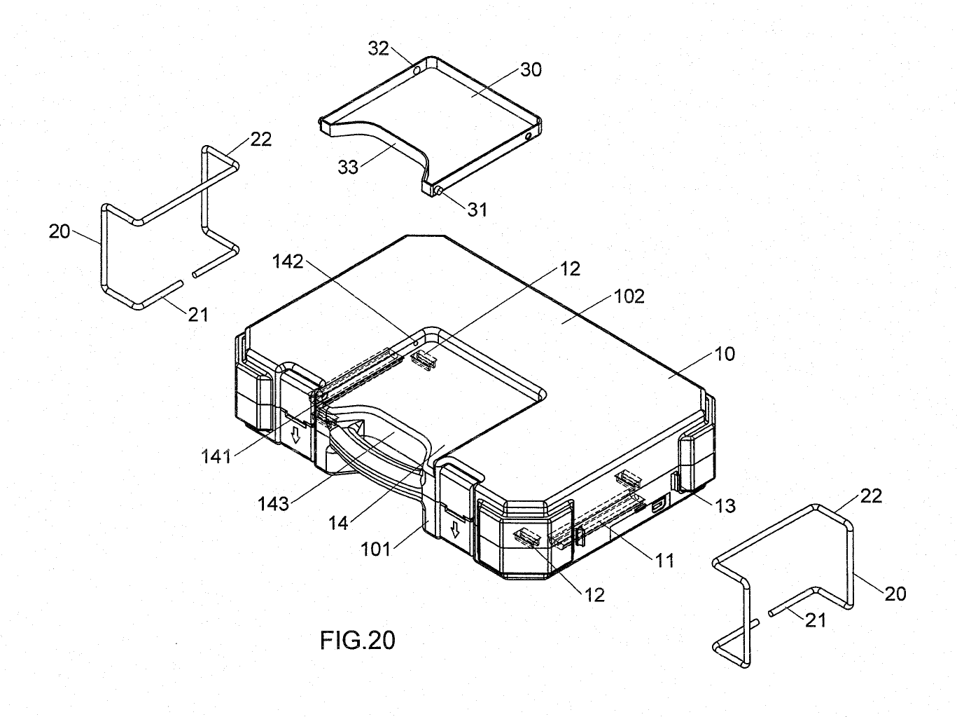

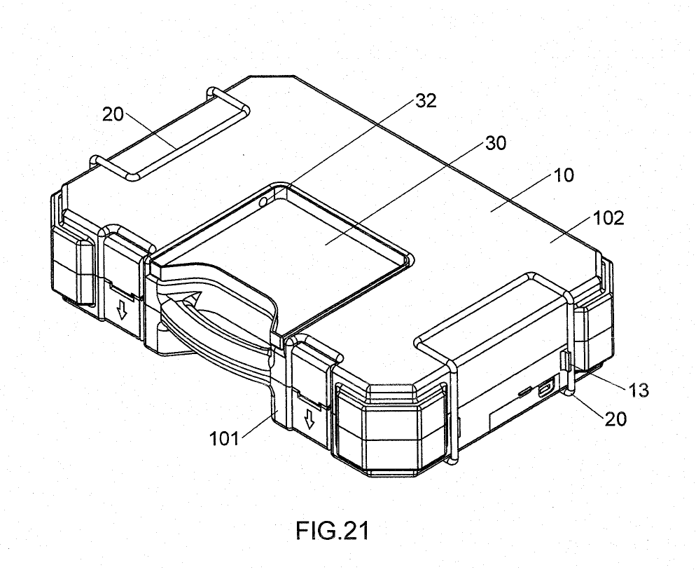

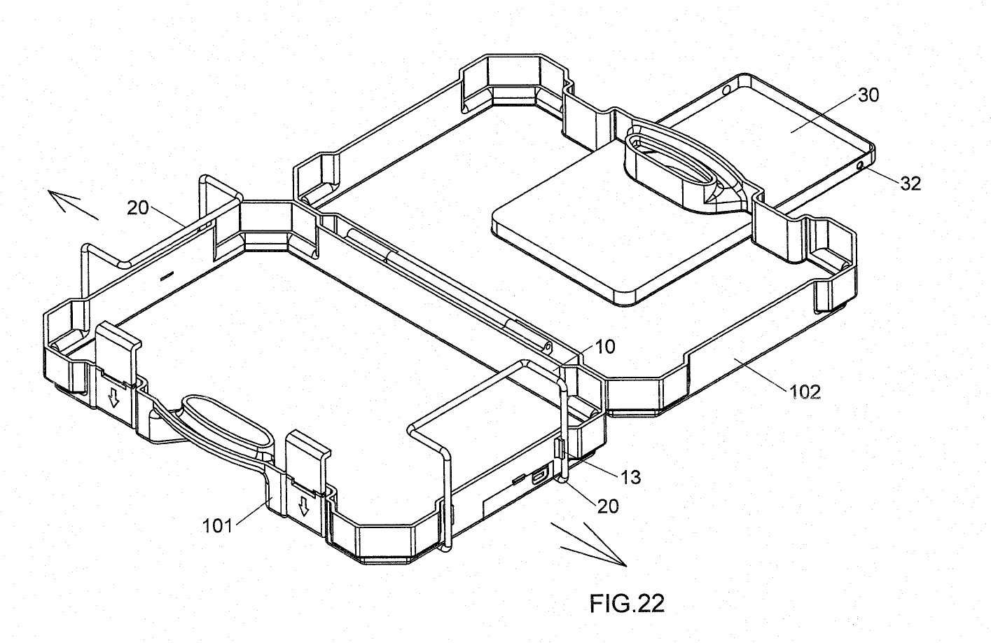

As shown in FIGS. 20 to 22, which show the tenth embodiment, wherein the tool box does not have the illumination member 60. As shown in FIG. 22, when the body 10 opens, the tools are received in the body 10 and the part box 30 is expanded from the body 10 to receive parts.

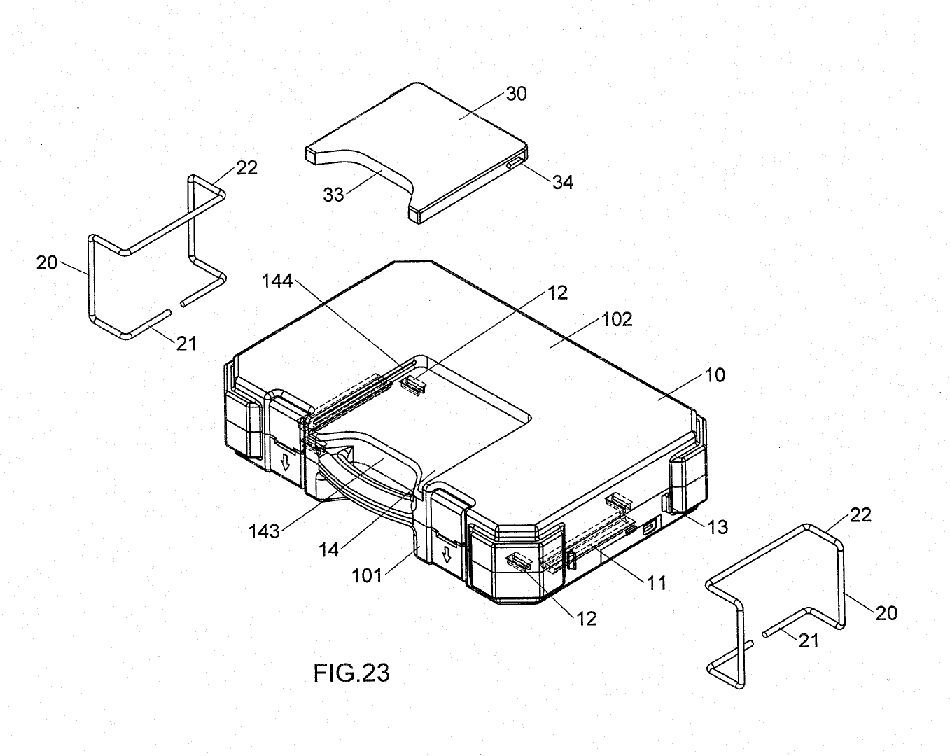

As shown in FIG. 23 which show the eleventh embodiment, wherein the body 10 has elongate first rails 144 on two sides of the recessed area 14 and the two sides of the part box 30 each have a second rail 34 which is slidably connected to the first rail 144 corresponding thereto.

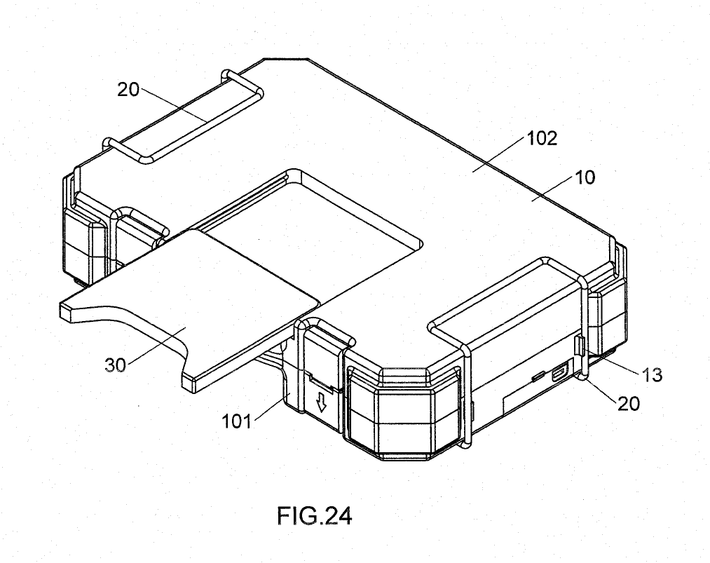

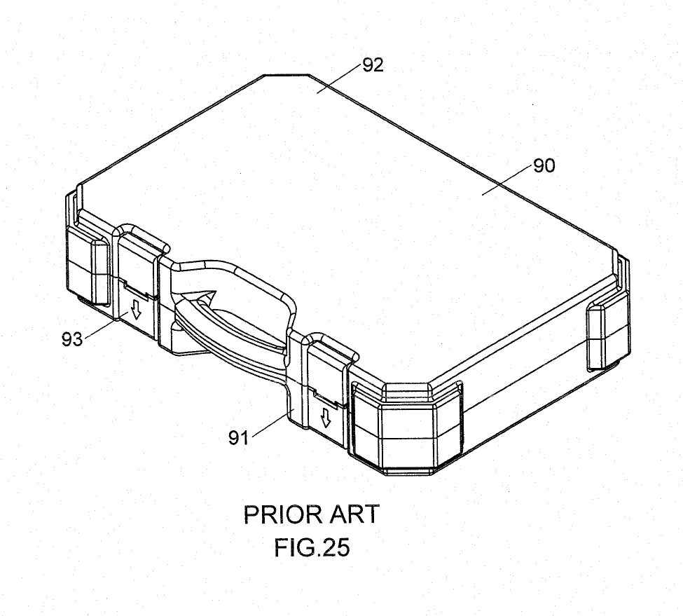

As shown in FIG. 24 which shows the eleventh embodiment, wherein second rails 34 of the part box 30 are slidably connected to the first rails 144 so that the part box 30 is slidably extended from the body 10.

The reception recess 15 has the protrusion 151 and the locking recess 152, so that the power supply member 40 can be connected to the body 10 by the protrusion 151 and the locking recess 152.

Another embodiment of the present invention comprises multiple reception recesses 15, and each reception recess 15 has one power supply members 40 and one illumination members 60 received therein so as to illuminate different areas.

The power supply members 40 and the illumination members 60 can be an one-piece design, wherein the illumination members 60 directly connected to the power supply members 40.

The tool box of the present invention provides support frames 20 pivotably connected to the body 10, and the leg portions 22 are located corresponding to the first pivotable portions 11. The support frames 20 are mounted to the two sides of the body 10. When the body 10 drops on the floor, the locking units and the support frames 20 do not fail simultaneously, the top part 102 and the bottom part 101 are not opened unexpectedly.

As shown in FIG. 2, the support frames 20 are located on two sides of the frame 10 and do not occupy space when the support frames 20 are folded toward the body 10.

When the tool box stands upright, the support frames 20 support the bottom of the body 10 and the surface of the tool box does not easily contaminated.

The support frames 20 each are made by bending a tube into two U-shaped portions and this can be made at low cost.

When the support frames 20 are pivotably connected to the bottom of the body 10, the body 10 is maintained its whole shape and the support frames 20 do not affect the functions of the tool box. The body 10 can be made by the same molds.

The body 10 has a recessed area 14 for accommodating the part box 30 which allows the users to organize the tools and the parts.

The tool box has the power supply member 40 and the illumination member 60, so that the tool box can be used as a work bench with illumination feature.

The illumination member 60 is stored in the tool box and does not lost.

The tool box has a light reception portion 153 for receiving the illumination member 60 so that the users can easily get the illumination member 60.

The power supply member 40 has multiple charging terminals of different specifications so as to charge the power supply member 40.

The power supply member 40 has the power supply end 41 such as the UBS port, so as to charge the electronic devices via the power supply member 40.

While we have shown and described the embodiment in accordance with the present invention, it should be clear to those skilled in the art that further embodiments may be made without departing from the scope of the present invention.

What is claimed is:

1. A tool box comprising:
a body having a bottom part, a top part and at least one locking unit, the body having two first pivotable portions, two first engaging portions located close to each of the first pivotable portions, each first engaging portion being a slot, the body having two second engaging portions on each of two sides thereof and each second engaging portion being a slot and located corresponding to the first engaging portion, the first pivotable portions, the first engaging portions and second engaging portion located on the bottom part, the body having at least one recessed area, a reception recess defined in one side of the body;
two support frames and each being made by bending a tube into two U-shaped portions, each support frame having two second pivotable portions which are pivotably connected the first pivotable portions, each support frame having two leg portions which are located corresponding to the first pivotable portions when the second pivotable portions are pivotably connected the first pivotable portions, the support frames mounted to two sides of the body and the second pivotable portions located at bottom of the body and the leg portions located on a top of the body, each support frame being engaged with the second engaging portion;
when operating the support frames, the leg portion of each support frame is removed from the top of the body and each of the support frames is separated from the second engaging portion, each of the two support frames is pivoted about the first pivotable portion and supports the bottom of the body, each of the two support frames is engaged with the first engaging portion so that the body stands on a surface by the support frames;
a part box engaged with the recessed area;
a power supply member located in the reception recess and having at least one power supply end and at least one charging terminal, the at least one power supply end is a USB port, and
an illumination member having a power supply terminal on one end thereof and the power supply terminal connected to the at least one power supply end, the illumination member being powered by the power supply member, the illumination member connected with a flexible handle.

2. The tool box as claimed in claim 1, wherein there is one recessed area and two third pivotable portions are formed on two sides of the recessed area respectively, each third pivotable portion has a first positioning portion which is a boss, two fourth pivotable portions are formed on two sides of the part box respectively and pivotably connected to the third pivotable portions of the body, the part box has a second positioning portion which is a recess with which the first positioning portion is engaged so that the part box is engaged with the recessed area, when the second positioning portion is separated from the first positioning portion, the part box is pivotable relative to the body.

3. The tool box as claimed in claim 1, wherein the recessed area has a first recess which defines a gap relative to the handle, the part box has a second recess which has the same curvature as the first recess.

4. The tool box as claimed in claim 1, wherein the reception recess is an elongate recess and is located at the bottom part.

5. The tool box as claimed in claim 1, wherein the second pivotable portion of each support frame is located in a mold of the body, when the body is formed, the second pivotable portion is pivotably connected to the first pivotable portion.

6. The tool box as claimed in claim 1, wherein there are multiple charging terminals of different specifications.

7. The tool box as claimed in claim 1, wherein a cover is engaged with the reception recess and restricts the power supply member in the reception recess, the cover has at least one second notch from which the at least one charging terminal is exposed.

8. The tool box as claimed in claim 7, wherein the power supply terminal extends through the second notch and is connected to the at least one charging terminal.

9. The tool box as claimed in claim 1, wherein the illumination member is stored in the reception recess.

10. The tool box as claimed in claim 1, wherein the reception recess has multiple protrusions located on two sides thereof, each protrusion is an elongate protrusion, the protrusions restrict the power supply member in the reception recess.

11. The tool box as claimed in claim 1, wherein a locking recess is defined above the reception recess and the power supply member has a locking portion which is engaged with the locking recess to position the power supply member in the reception recess.

12. The tool box as claimed in claim 1, wherein the reception recess has a light reception portion and a first notch which opens to outside of the body, the reception recess is located at the top part when the power supply terminal is connected to the power supply end, the illumination member is bent and received in the light reception portion, when using the illumination member, the illumination member extends through the first notch and protrudes beyond the body.

13. The tool box as claimed in claim 1, wherein the first pivotable portion is a slot and the second pivotable portion is engaged with the first pivotable portion.

14. The tool box as claimed in claim 1, wherein the body has two first slots defined in the top part thereof, each first slot has a fifth pivotable portion which is a hole, multiple top portions each have a sixth pivotable portion which is pivotably connected to the fifth pivotable portion, each of the top portion is pivotably engaged with the first slot, when the body stands upright, the support frames support the bottom part and the top portions support the top part.

15. The tool box as claimed in claim 1, wherein the reception area of the body has two elongate first rails on two sides thereof and the part box has two second rails on two sides thereof, the first rails slidably connected to the second rails.

16. The tool box as claimed in claim 1, wherein there are multiple reception recesses, each reception recess has one power supply member and one illumination member received therein.
